(19) United States
(12) Patent Application Publication
(10) Pub. No.: US 2016/0355200 A1
(43) Pub. Date: Dec. 8, 2016

(54) ROUTE WARRANT SYSTEM AND METHOD

(71) Applicant: ALSTOM TRANSPORT TECHNOLOGIES, Saint-Ouen (FR)

(72) Inventor: Christopher Barry Horne, Melbourne, FL (US)

(21) Appl. No.: 15/170,828

(22) Filed: Jun. 1, 2016

Related U.S. Application Data
(60) Provisional application No. 62/170,250, filed on Jun. 3, 2015.

(51) Int. Cl. B61L 27/00; G01C 21/36

(52) U.S. Cl. CPC B61L 27/0011; G01C 21/36

(57) ABSTRACT

A system and method for determining a route warranty for one or more vehicle systems determine plural different paths for a trip of a first vehicle system from an origin location to a destination location in a transportation network formed from paths interconnected with each other at nodes, determine whether travel by the first vehicle system along the different routes fails one or more tests that restrict how the first vehicle system travels in the transportation network, and determine a route warranty for the first vehicle system based on the one or more tests. The route warranty reserves one or more of the paths for travel by the first vehicle system from the origin location to the destination location such that other vehicle systems are prevented from traveling on the one or more of the paths reserved by the route warranty.

### FIELD

Embodiments of the subject matter disclosed herein relate to determining route warrants for vehicle systems traveling in a transportation network.

### BACKGROUND

Transportation networks formed from many interconnected routes may be concurrently traveled by several different vehicles. For example, networks of tracks may be traveled by many trains at the same time. In order to ensure safe and timely travel of the trains, track warranties may be issued for the trains. The track warrants can designate which tracks and switches are to be traveled over by the trains at various times. Typically, different dispatch facilities control movement of trains in areas governed by the different dispatch facilities use different track warrants to control where and when the trains move in the respective areas.

Track warrants currently are generated by finding a direct line between a starting location and an ending location for a scheduled trip of a train. Using this direct line, the tracks and switches that are closest to this direct line are included in a track warranty for the trip of the train. Other lines or paths between the starting and ending locations typically are not considered.

Because many trains may need to concurrently travel in the same network of tracks, many different trains may have track warrants that include the same tracks and/or switches. In order to prevent the trains from colliding, the schedules of the trains are established so that some trains are forced to wait for a track in the warrants of those trains is clear. As a result, the consideration of only the tracks and switches that are on or near the direct line between starting and ending locations for the trip can pose many scheduling problems.

### BRIEF DESCRIPTION

In one embodiment, a method (e.g., for determining a route warranty for one or more vehicle systems) includes determining plural different paths for a trip of a first vehicle system from an origin location to a destination location in a transportation network formed from paths interconnected with each other at nodes, determining whether travel by the first vehicle system along the different routes fails one or more tests that restrict how the first vehicle system travels in the transportation network, and determining a route warranty for the first vehicle system based on the one or more tests. The route warranty reserves one or more of the paths for travel by the first vehicle system from the origin location to the destination location such that other vehicle systems are prevented from traveling on the one or more of the paths reserved by the route warranty.

In one embodiment, a system (e.g., for determining a route warranty for one or more vehicle systems) includes one or more processors configured to determine plural different routes for a trip of a first vehicle system from an origin location to a destination location in a transportation network formed from paths interconnected with each other at nodes. The one or more processors also are configured to determine whether travel by the first vehicle system along the different routes fails one or more tests that restrict how the first vehicle system travels in the transportation network. The one or more processors also are configured to determine a route warranty for the first vehicle system based on the one or more tests. The route warranty reserves one or more of the paths for travel by the first vehicle system from the origin location to the destination location such that other vehicle systems are prevented from traveling on the one or more of the paths reserved by the route warranty.

In one embodiment, a method (e.g., for determining a track warranty for one or more rail vehicle systems) includes determining plural different routes for a trip of a rail vehicle system from an origin location to a destination location in a transportation network formed from tracks interconnected with each other at switches, determining whether travel by the rail vehicle system along the different routes fails one or more tests that restrict how the rail vehicle system travels in the transportation network, and determining a track warranty for the rail vehicle system based on the one or more tests, the route warranty reserving one or more of the tracks and one or more of the switches for travel by the rail vehicle system from the origin location to the destination location such that other rail vehicle systems are prevented from traveling on the one or more of the tracks and the one or more of the switches reserved by the track warranty.

### BRIEF DESCRIPTION OF THE DRAWINGS

Reference is made to the accompanying drawings in which particular embodiments and further benefits of the invention are illustrated as described in more detail in the description below, in which:

FIG. 1 illustrates one embodiment of a route warranty system;

FIG. 2 illustrates a vehicle system according to one embodiment;

FIG. 3 illustrates a transportation network according to one embodiment;

FIG. 4 illustrates several via switches between routes according to one example;

FIG. 5 illustrates several via switches between routes according to another example;

FIG. 6 illustrates several via switches between routes according to another example;

FIG. 7 illustrates a switch between routes according to another example;

FIG. 8 illustrates switches and routes for another potential path of the vehicle system according to another example;

FIG. 9 illustrates switches and routes for another potential path of the vehicle system shown in FIG. 2 according to another example; and

FIGS. 10A and 10B illustrate a flowchart of one embodiment of a method for determining a route warrant for a vehicle system.

### DETAILED DESCRIPTION

Embodiments of the inventive subject matter described herein relate to methods and systems for determining route warrants for vehicle systems. Route warrants are used to authorize vehicle systems (such as trains) to occupy routes, such as main tracks located outside of the limits of rail yards. Different authorities (e.g., scheduling systems, dispatchers, etc.) dictate movement of the vehicle systems in different areas (which may or may not overlap with each other). The systems and methods described herein provide validation logic to authorize vehicle systems for passage along the routes while ensuring that the limits of one authority do not overlap with another authority.

In one aspect, the systems and methods described herein can represent a transportation network formed of several interconnected routes as a series of associated nodes connected through paths stored in one or more memory structures (e.g., tables, lists, etc.). The nodes can represent intersections between paths and/or switches at such intersections. With a starting location and final or next destination location for a trip of a vehicle system provided to the systems and methods, the systems and methods can identify the nodes at or near the starting and destination locations, and then search through the nodes between these starting and destination nodes to find one or more routes that the vehicle system can traverse to reach the destination location. The systems and methods can return an indexed data set that represents the paths found between the starting and destination nodes. The systems and methods may translate the lists of nodes between the logical route topology, switches, and named locations along the routes and/or near the nodes.

Tables (or other memory structures) can store and provide the logical points (e.g., nodes) and the connections (e.g., routes) between the points. The nodes can be associated with a reference identification to a switch at or near the node, which can be used to identify physical location parameters associated for each route. The systems and methods can use this information to search through potential routes (e.g., paths and switches between the starting and destination locations) and nodes to determine whether a valid path exists between the nodes. The resulting data set from the search can include an indexed list of nodes traversed by the various routes. The physical location parameters can be used to allocate the tracks and switches associated with a selected path to a vehicle system in a route warrant. This warrant can assign the tracks and switches to the vehicle system during a trip of the vehicle system to ensure that no other vehicle systems occupy the same switch or same track segment at the same time as the vehicle system having the route warrant.

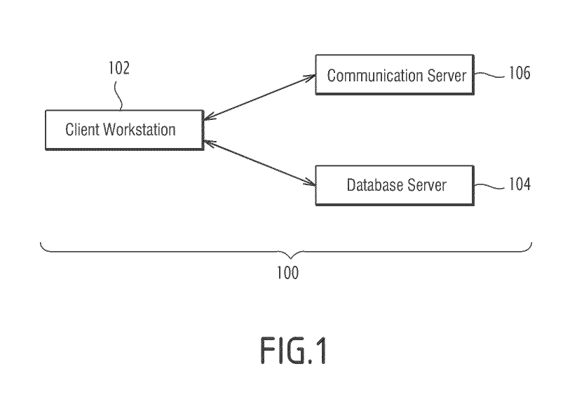

FIG. 1 illustrates one embodiment of a route warranty system 100. The system 100 is responsible for creation and validation of the warrants for several vehicles traveling in a transportation network formed by several interconnected routes. The system 100 includes one or more client workstations 102, which can represent one or more computing devices, such as one or more desktop computers, mobile computers (e.g., tablet computers, smart phones, etc.), that have one or more processors for performing the operations described herein. The system 100 supports simultaneous operation on multiple client workstations 102, which access a database server 104 for authority validation operations. The database server 104 represents one or more memory structures, such as computer servers, computer hard drives, or the like. The database server 104 can store information used by the client workstations 102 to determine route warrants for different vehicle systems, such as locations of routes, nodes (e.g., intersections or switches), speed limits, and the like. A communication server 106 represents one or more memory structures and processors that enable communication between the client workstations and the database server 104.

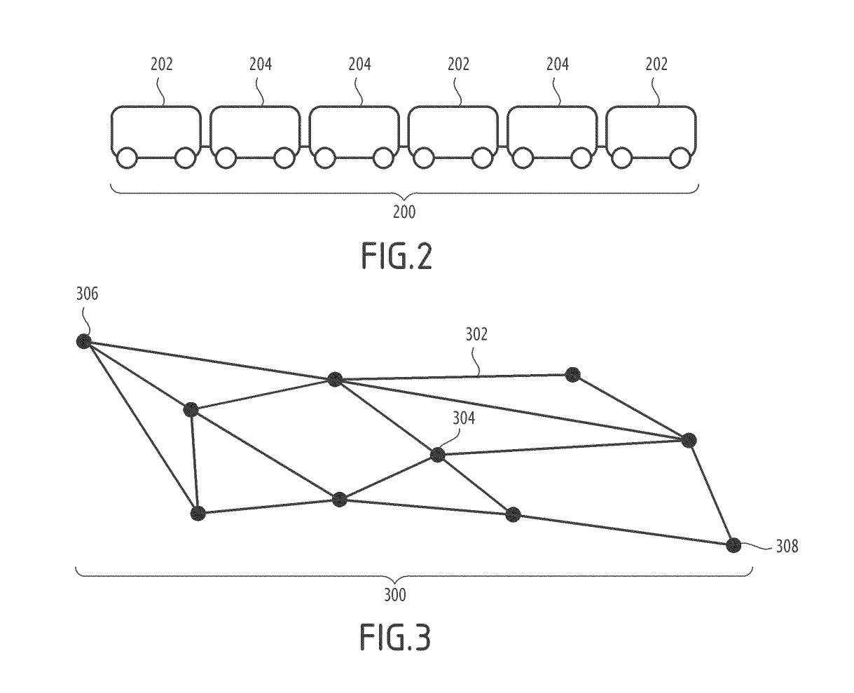

FIG. 2 illustrates a vehicle system 200 according to one embodiment. The vehicle system 200 includes several vehicles 202, 204 that travel together along a route. The vehicles 202 can represent propulsion-generating vehicles, such as locomotives. Alternatively, the vehicles 202 can represent automobiles, marine vessels, or the like. The vehicles 204 can represent non-propulsion-generating vehicles, such as rail cars, trailers, or the like. The vehicles 202, 204 may be mechanically coupled with each other to travel together along a route, or may be separate from each other but communicate with each other to coordinate travel along a route.

FIG. 3 illustrates a transportation network 300 according to one embodiment. The transportation network 300 is formed from several interconnected paths 302, such as tracks, roads, or the like. The paths 302 intersect one another at several nodes 304. The nodes 304 can represent switches between the paths 302 or other intersections between the paths 302. The system 100 shown in FIG. 1 can determine potential routes for the vehicle system 200 (shown in FIG. 2) to travel from an origin location 306 in the transportation network 300 to a destination location 308 in the transportation network 300.

In order to create a route warrant for a trip of the vehicle system 200 from the origin location 306 to the destination location 308, the client workstation 102 may identify the origin and destination locations, and the database server 104 can determine nodes 304 that are at or near the origin location and the destination location. The origin location may not be at the exact same location as a node 304, and the database server 104 can identify which node 304 is close or closest to the origin location and identify this node 304 as the origin location 306. Similarly, the database server 104 can identify which node 304 is close or closest to the destination location and identify this node 304 as the destination location 308.

The client workstation 102 and/or the database server 104 can then search through different combinations of paths 302 and nodes 304 in order to determine different potential routes from the origin location 306 to the destination location 308. Some of these routes may not extend along a straight line or may not represent the shortest possible distance between the origin and destination locations 306, 308 along the paths 302 and nodes 304.

For some types of vehicle systems 200 and paths 302, not all routes between the origin location 306 and destination location 308 may be traveled by the vehicle systems 200. For example, for rail vehicles, some paths 302 may restrict the direction in which the vehicle systems 200 travel, some switches may restrict the directions that the vehicle systems 200 can travel, or the like. Some paths 302 may already be reserved by other vehicle systems 200 in warrants for those vehicle systems 200. As a result, not all permutations of combinations of the paths 302 and nodes 304 can be used to form potential paths.

The client workstation 102 and/or the database server 104 can examine the routes that are determined in order to determine if any of the routes should be eliminated as possibilities for the trip of the vehicle system 200 from the origin location 306 to the destination location 308. In one aspect, the client workstation 102 and/or the database server 104 can perform a double via cross-over test on the routes to determine if any of the routes include the vehicle system 200 changing paths 302 by traveling over at least one switch in each of consecutive sets of two or more switches.

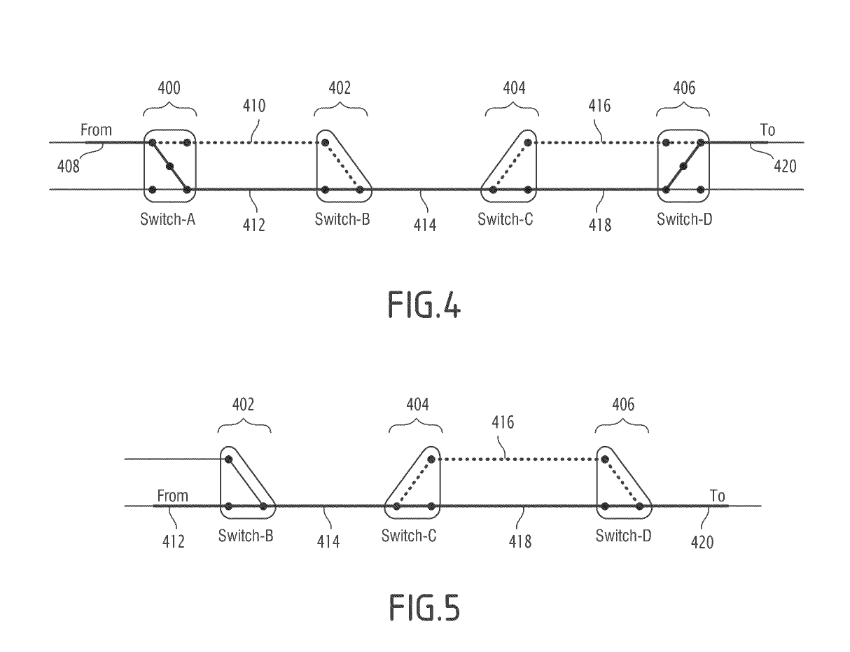

FIG. 4 illustrates several via switches between routes according to one example. As shown in FIG. 4, a first path 408 connects with a first switch 400, which is connected with second and third paths 410, 412 to a second switch 402. A fourth path 414 connects the second switch 402 with a third switch 404, which is connected with fifth and sixth paths 416, 418 to a fourth switch 406. The fourth switch 406 is connected with a seventh path 420. The switches 400, 402 are consecutive switches in a first set of switches and the switches 404, 406 are consecutive switches in a second set of switches. The first and second sets of switches are consecutive along the route being examined. For example, a vehicle system traveling along the route will pass over at least one of the switches in the first set and one or more of the switches in the second set before traveling over any other switches or sets of switches. The paths 408, 410, 412, 414, 416, 418, 420 may represent some of the paths 302 shown in FIG. 3 and the switches 400, 402, 404, 406 may represent some of the nodes 304 shown in FIG. 3.

In one embodiment, the client workstation 102 and/or database server 104 can examine potential paths to determine if any of the paths include a double via cross-over. A double via cross-over occurs when a route includes a vehicle system 200 changing direction and moving from one path to another path by passing over at least one switch in each of consecutive sets of switches. For example, if a route includes the vehicle system 200 traveling on the path 408 to the switch 400, changing direction by crossing to the path 412 via the switch 400, traveling along the paths 412, 414, 418, and changing direction by crossing over to the path 420 via the switch 406, then such a route includes a double via cross-over. As another example, if a route includes the vehicle system 200 traveling on the path 408 to the switch 400, traveling on the path 410 to the switch 402, crossing over to the path 414 via the switch 402, crossing over to the path 416 via the switch 404, and then traveling on the paths 416, 420, then such a route includes a double via cross-over.

If a route includes a double via cross-over, then that route may be eliminated from the list of potential routes between the origin location 306 and the destination location 308. For example, an acceptable route may only include a single via cross-over in one embodiment. Alternatively, an acceptable route may include a larger number of via cross-overs. In another example, a route may include a double via cross-over so long as the double via cross-over does not violate any restrictions on directions of travel along paths 408, 410, 412, 414, 416, 418, 420 and/or switches 400, 402, 404, 406. For example, the path 410 and/or the route 416 may only allow travel in a right-to-left direction in FIG. 4. A route that directs a vehicle system 200 to travel in a left-to-right direction in FIG. 4 along the path 410 and/or the path 416 may be eliminated from the list of potential routes.

FIG. 5 illustrates several via switches between paths according to another example. Another test that can be performed on a potential routes includes a direct path test. In this test, the client workstation 102 and/or database server 104 examines the paths and switches of a route to determine if the route includes a direct, non-divergent path or if the route includes a possible divergent path. For example, if the route includes a direct path segment between two locations separated from each other by one or more switches that connect the direct path segment with a divergent path segment, then this test can determine whether the route causes the vehicle system 200 to travel directly between the two locations along the direct path segment or whether the route causes the vehicle system 200 to not travel directly between the two locations (e.g., by leaving the direct path segment by crossing over a switch, traveling over another path segment, and then returning to the direct path segment by crossing over another switch). The paths and switches shown in FIG. 5 can represent some of the paths and nodes, respectively, shown in FIG. 3.

In FIG. 5, the route includes the vehicle system 200 traveling along the path 412 to the path 414 via the switch 402, to the path 418 via the switch 404, and to the path 420 via the switch 406. Because this path does not include a divergent path, such as a path that moves from the path 414 to the path 416 via the switch 404 and then back to the path 420 via the switch 406, this route may still be an acceptable route. A route that includes the divergent path, however, may not be an acceptable route. For example, a route that directs the vehicle system 200 to leave the direct path along paths 414, 418, 420 for travel on the path 416 may be an unacceptable divergent route. The client workstation 102 and/or the database server 104 may identify the divergent path by determining whether the route being examined includes two or more switches between two locations along the path, and the path causes the vehicle system to travel from one location, cross over one switch to leave a path and travel along a divergent path then cross over another switch to leave the divergent path to travel to the other location. Such a route may be eliminated from the list of potential routes.

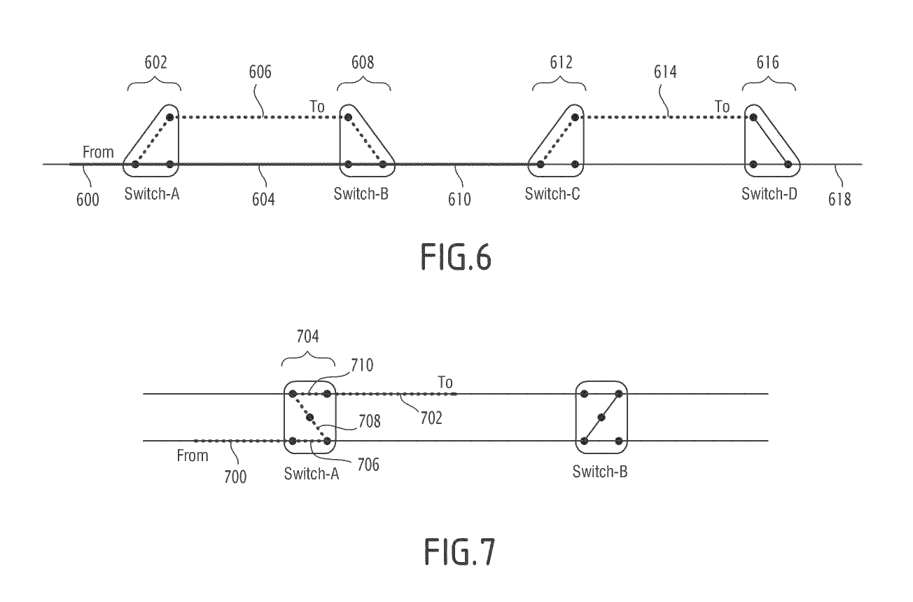

FIG. 6 illustrates several via switches between paths according to another example. Another test that can be performed on a potential path includes an unsupported route test. In this test, the client workstation 102 and/or database server 104 examines the paths and switches of a route to determine if the route includes a path that the vehicle system 200 is not permitted to travel along. Some paths can have restrictions that prevent certain or all vehicle systems from traveling on the paths. For example, a vehicle system 200 may be prevented from traveling along a path if the path is being repaired, if the path has an upper weight limit that is exceeded by the vehicle system 200, or the like. As another example, if the vehicle system 200 is an electric vehicle system 200 that is powered by an overhead catenary, an electrified rail, or the like, and a path does not have an overhead catenary, electrified rail, or other device for powering the vehicle system 200, then the vehicle system 200 may not be permitted for travel on the route. As another example, if the vehicle system 200 is carrying hazardous material and a route extends through an urban area where such materials are prohibited, then the vehicle system 200 may not be permitted for travel on the route. If a route identified by the client workstation 102 and/or database server 104 includes a path that the vehicle system 200 is not permitted to travel along, then that route may be eliminated from the list of potential routes.

In FIG. 6, a first path 600 connects with a first switch 602, which is connected with second and third paths 604, 606. The paths 604, 606 are connected with a second switch 608, which is connected with a fourth path 610. The path 610 is connected with a third switch 612, which is connected with a fifth path 614. The fifth path 614 is connected with a fourth switch 616, which is connected with a sixth path 618. The paths and switches shown in FIG. 6 can represent some of the paths and nodes, respectively, shown in FIG. 3.

The database server 104 may store restrictions associated with the path 606, and the client workstation 102 and/or database server 104 can determine if travel along the path 606 in a potential route will violate any of the restrictions. If the path 606 has one or more restrictions that prevent the vehicle system 200 from traveling on the path 606, then the client workstation 102 and/or database server 104 can eliminate the route that includes travel along the path 606 from consideration. As a result, the route including the path 606 may be discarded or otherwise removed from the list of potential routes. Another route (e.g., that does not include the path 606) may remain in the list of potential paths.

FIG. 7 illustrates a switch 704 between paths according to another example. Another test that can be performed on a potential route includes an invalid normal “Z” reverse path test. In this test, the client workstation 102 and/or database server 104 examines the paths and switches of a route to determine if the route causes the vehicle system 200 to double back through a switch 704. For example, the switch 704 may include non-intersecting path segments 706, 710 joined by an intersecting segment 708. The intersecting segment 708 may be the part of the switch 704 that moves to change where the vehicle system 200 is directed toward upon traveling over the switch 704. The paths and switches shown in FIG. 7 can represent some of the paths and nodes, respectively, shown in FIG. 3.

A route that includes the switch 704 may direct the vehicle system 200 to enter into the switch 704 along a first direction (e.g., from a path 700 onto the segment 706), then turn to at least partially reverse direction (e.g., switch from travel over the segment 706 to travel over the segment 708), then turn to at least partially reverse direction again (e.g., switch from travel over the segment 708 to travel over the segment 710), and then exit the switch 704 along a path 702. For example, the path may direct the vehicle system 200 to enter the switch 704 through the normal switch leg and exit through the reverse switch leg, or enter through the reverse switch leg and exit through the normal switch leg. Because some vehicle systems may be unable to travel in this manner, this path will be excluded from the list of potential paths. For example, rail vehicles may be unable to reverse directions during travel over the switch 704. As a result, the path shown in FIG. 7 fails the invalid normal “Z” reverse path test and is excluded from the list of potential paths.

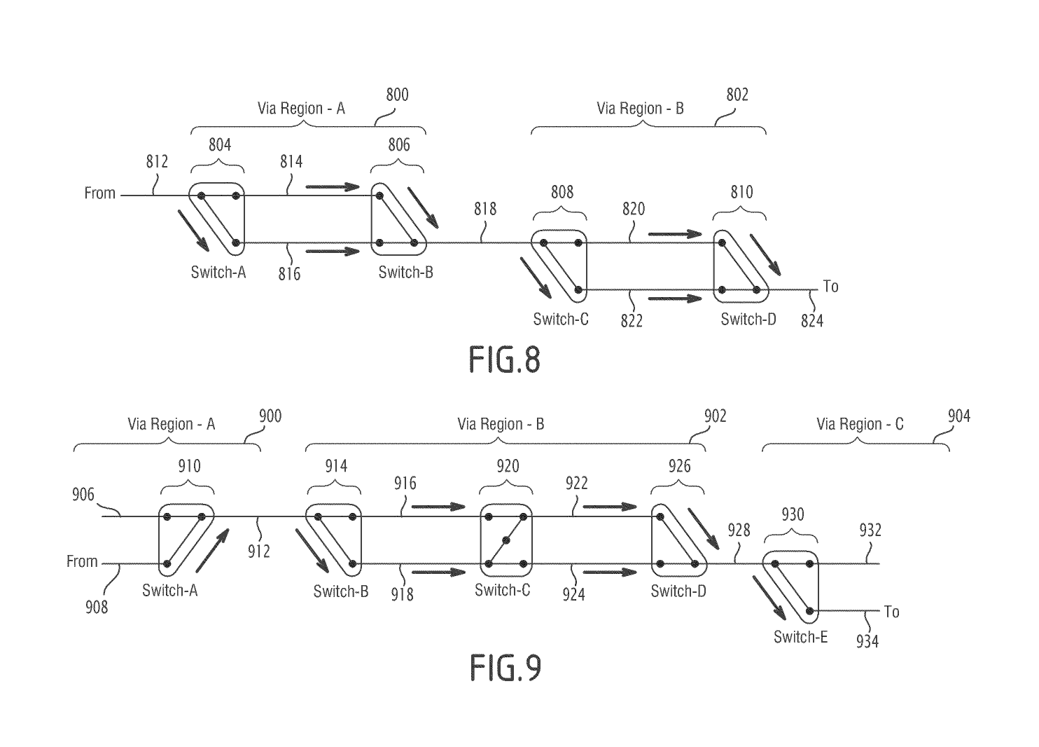

FIG. 8 illustrates switches and paths for another potential route of the vehicle system 200 according to another example. Another test that can be performed on a potential route includes a via region test. In this test, the client workstation 102 and/or database server 104 examines how close multiple switches 804, 806, 808, 810 are to each other and/or to a station (e.g., a train station) to determine whether a route warrant can be placed on the switches 804, 806, 808, 810. A route warrant for one vehicle system 200 can restrict travel on the same paths and/or switches in the route warrant by other vehicle systems. This test seeks to avoid reserving too many switches and/or routes that are close to each other and/or a station for only a single vehicle system 200.

In the illustrated example, a first path 812 leads into a first via region 800. The first via region 800 includes several switches 804, 806 that are connected by non-intersecting paths 814, 816. The first via region 800 is connected with a second via region 802 by a path 818. The second via region 802 includes several switches 808, 810 connected by non-intersecting paths 820, 822. The second via region 802 also is connected with a path 824. The via regions 800, 802 may be defined as an area encompassing switches that are within a designated distance of each other (e.g., 5 kilometers, 10 kilometers, or another distance) and/or within a designated distance of a station (e.g., 5 kilometers, 10 kilometers, or another distance). The paths and switches shown in FIG. 8 can represent some of the paths and nodes, respectively, shown in FIG. 3.

For those routes that extend through one or more via regions 800, 802, the client workstation 102 and/or database server 104 can examine the via regions 800, 802 to determine whether multiple paths 814, 816, 820, 822 extend through the via regions 800, 802. The client workstation 102 and/or database server 104 can look for the multiple paths 814, 816, 820, 822 through the via regions 800, 802 and, if multiple paths 814, 816, 820, 822 are found, then the route may be a valid route and remain in the list of potential routes. In the example shown in FIG. 8, each of the via regions 800, 802 has two non-intersecting paths 814, 816, 820, 822 between the switches 804, 806, 808, 810. For example, the via region 800 includes the paths 814, 816 between the switches 804, 806 and the via region 802 includes the paths 820, 822 between the switches 808, 810.

The presence of the plural paths between the switches in a via region 800, 802 can mean that a route warrant can be issued for a vehicle system 200 that reserves one of the paths in the via regions 800, 802. For example, a routes that includes the switch 804, one (but not both) of the paths 814, 816, the switch 806, the path 818, the switch 808, one (but not both) of the paths 820, 822, the switch 810, and the path 824 may be a valid route because reserving only one of the paths 814 or 816 and only one of the paths 820 or 822 in a route warrant keeps the other paths 816 or 814 and the other path 822 or 820 available for travel by another vehicle system. As a result, such a route would pass the via region test. But, if only a single route existed between the switches 804, 806 in the via region 800 or if only a single route existed between the switches 808, 810 in the via region 802, then a route that includes either of these single paths would fail the via region test. Such a route would fail the test because a route warrant that includes the route could create a traffic bottleneck at or near the via region 800, 802. As a result, the route would be excluded from the list of potential routes.

FIG. 9 illustrates switches and paths for another potential route of the vehicle system 200 according to another example. Another test that can be performed on a potential route includes a single via switch region test. In this test, the client workstation 102 and/or database server 104 examines whether any via region includes a single path exiting out of or entering into a switch within the via region. Such a route may create a bottleneck in traffic if a route warrant reserves the route for one vehicle system 200.

In the illustrated example, three via regions 900, 902, 904 are provided. The via region 900 includes two paths 906, 908 leading into a switch 910 and a single path 912 leading out of the switch 910. The via region 902 includes three switches 914, 920, 926, with the single path 912 leading into the switch 914, two paths 916, 918 extending between the switch 914 and the switch 920, two paths 922, 924 extending between the switch 922 and the switch 926, and a single path 928 leading out of the switch 926. The via region 904 includes a switch 930 with the single path 928 leading into the switch 930 and two paths 932, 934 leading out of the switch 930. The paths and switches shown in FIG. 9 may represent the paths 302 and nodes 304, respectively, shown in FIG. 3.

For those routes that extend through one or more via regions 900, 902, 904, the client workstation 102 and/or database server 104 can examine the paths in the routes to determine if any of the routes include a single route leading into and/or out of a via region 900, 902, 904. These types of single paths can create traffic problems if the single paths are reserved in a route warrant for a vehicle system. For example, the client workstation 102 and/or database server 104 may not want to reserve either of the paths 912, 928 in a route warrant for the vehicle system 200 because doing so may create a bottleneck behind the reserved path 912, 928. Therefore, any route having a single route 912, 928 extending into or out of a via region 900, 902, 904 would fail this test because a route warrant that includes the path could create a traffic bottleneck at or near the via region. As a result, the route would be excluded from the list of potential routes.

After searching through the multiple potential routes through different combinations of the paths and the nodes (e.g., the switches), and then eliminating some routes that fail one or more of the tests described herein, the client workstation 102 and/or database server 104 may have a list of potential routes that will cause the vehicle system 200 to travel to the origin location to the destination location without violating the tests on the various paths. The client workstation 102 may present these routes to an operator of the system 100, such as in a list of routes. Each route may be represented by a list or table of the switches that the vehicle system 200 will travel through from the origin location to the destination location. Alternatively, the client workstation 102 may present these routes in another manner, such as on a map.

A route may be selected for the vehicle system 200, and one or more other routes may be selected for one or more other vehicle systems. The selected routes for the vehicle systems then become route warrants for the vehicle systems. The route warrants may then be communicated to one or more other locations for implementation. For example, the route warrants may be communicated to several different dispatch locations that separately control movements of vehicle systems within different areas of the transportation network. These different dispatch locations may all have the same route warrants so that all dispatch locations are aware of the movements of vehicle systems moving into and/or out of the areas controlled by the dispatch locations. Optionally, the route warrants may be used control operation of the vehicle systems, switches, or the like. For example, the route warrants may be communicated to the vehicle systems for the vehicle systems to use in determining where the vehicle systems are to move and when the vehicle systems are to move throughout the transportation network. The route warrants may be communicated to the switches (or to systems that control operation of the switches) to cause the switches to change positions and connect the routes that are part of a route warrant for a vehicle system.

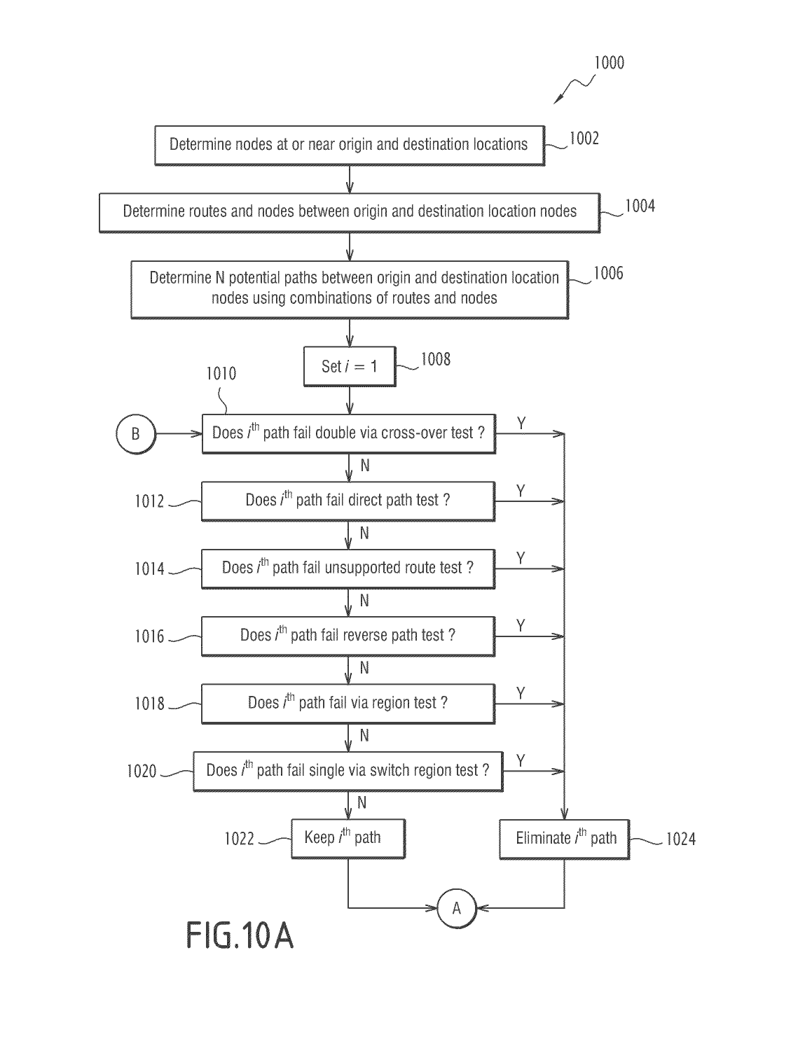

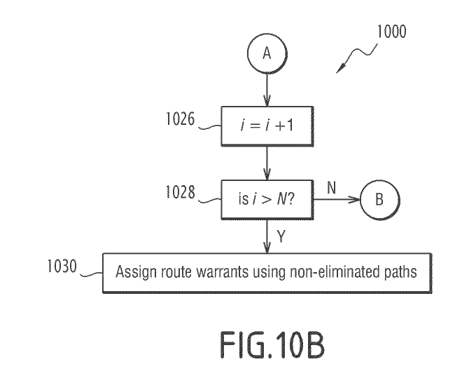

FIGS. 10A and 10B illustrate a flowchart of one embodiment of a method 1000 for determining a route warrant for a vehicle system. The method 1000 may be performed by one or more embodiments of the system 100 shown and described herein. At 1002, nodes that are at or near an origin location and a destination location for a trip of a vehicle system are determined. These nodes may be a node that is closer to the origin location than one or more (or all) other nodes and a node that is closer to the destination location than one or more (or all) other nodes. At 1004, paths and other nodes that are between the nodes of the origin and destination locations are determined. These nodes can include switches and the paths can include the paths that connect the switches.

At 1006, various potential routes between the nodes of the origin and destination locations are determined. These routes represent different combinations of the paths and nodes that will cause a vehicle system to travel from the node at or near the origin location to the node that is at or near the destination location. These routes may include one or more routes that do not extend along a straight path between the nodes of the origin and destination locations.

At 1008, a value of i is set to one. The value of i is used to iteratively examine and test the potential routes. At 1010, a determination is made as to whether the i^{th} potential route fails the double via cross-over test. As described above, this test examines whether the i^{th} potential route causes a vehicle system to moving across two switches to move between two paths in violation of a direction of travel restriction of any path. If the i^{th} potential route includes a double via cross-over, then that route may be eliminated from the list of potential routes between the origin location and the destination location. As a result, flow of the method 1000 can proceed toward 1024. But, if the i^{th} potential route does not include a double via cross-over, then that route may remain in the list of potential routes (subject to one or more other tests). As a result, flow of the method 1000 can proceed toward 1012.

At 1012, a determination is made as to whether the i^{th} potential route fails the direct path test. As described above, this test examines whether the i^{th} potential route causes a vehicle system to leave a first path, travel onto a divergent path, and then return to the first path (or a path that is an extension of the first path). For example, this test can examine whether the i^{th} potential route needlessly extends the length of the trip by having the vehicle system diverge from a shorter route between two consecutive switches. If the i^{th} potential route fails the direct path test, then that route may be eliminated from the list of potential routes between the origin location and the destination location. As a result, flow of the method 1000 can proceed toward 1024. But, if the i^{th} potential route passes the direct path test, then that route may remain in the list of potential paths (subject to one or more other tests). As a result, flow of the method 1000 can proceed toward 1014.

At 1014, a determination is made as to whether the i^{th} potential route fails the unsupported route test. As described above, this test examines whether the i^{th} potential route causes a vehicle system to travel along a path that the vehicle system is not permitted to travel along. If the i^{th} potential route fails the unsupported route test, then that route may be eliminated from the list of potential routes between the origin location and the destination location. As a result, flow of the method 1000 can proceed toward 1024. But, if the i^{th} potential route passes the unsupported route test, then that route may remain in the list of potential route (subject to one or more other tests). As a result, flow of the method 1000 can proceed toward 1016.

At 1016, a determination is made as to whether the i^{th} potential route fails the reverse path test. As described above, this test examines whether the i^{th} potential route causes a vehicle system to double back through a switch. For example, if the route causes the vehicle system to travel through a switch, then turn back and travel through the same switch again before exiting the switch, then the route fails the reverse path test. If the i^{th} potential route fails the reverse path test, then that route may be eliminated from the list of potential routes between the origin location and the destination location. As a result, flow of the method 1000 can proceed toward 1024. But, if the i^{th} potential route passes the reverse path test, then that route may remain in the list of potential routes (subject to one or more other tests). As a result, flow of the method 1000 can proceed toward 1018.

At 1018, a determination is made as to whether the i^{th} potential route fails the via region test. As described above, this test examines whether the i^{th} potential route includes a path that extends through a via region as the only path between switches in the via region. If the i^{th} potential route fails the via region test, then that route may be eliminated from the list of potential route between the origin location and the destination location. As a result, flow of the method 1000 can proceed toward 1024. But, if the i^{th} potential route passes the via region test, then that route may remain in the list of potential routes (subject to one or more other tests). As a result, flow of the method 1000 can proceed toward 1020.

At 1020, a determination is made as to whether the i^{th} potential route fails the single via switch region test. As described above, this test examines whether the i^{th} potential route extends through a via region having only a single route exiting out of or entering into a switch within the via region. If the i^{th} potential route fails the single via switch region test, then that route may be eliminated from the list of potential routes between the origin location and the destination location. As a result, flow of the method 1000 can proceed toward 1024. But, if the i^{th} potential route passes the single via switch region test, then that route may remain in the list of potential paths. As a result, flow of the method 1000 can proceed toward 1022.

At 1022, the i^{th} route remains in the list of potential routes for generating route warrants. Once the i^{th} route has passed the various tests, the route may be used to generate a route warrant for one or more vehicle systems. At 1024, however, the i^{th} route is eliminated from being considered for generating a route warrant for one or more vehicle systems. For example, because the i^{th} route failed one or more tests, the route may not be suitable for generating a route warrant. Following 1022 or 1024, flow of the method 1000 can proceed toward 1026 in FIG. 10B.

At 1026, the value of i is incrementally increased by one. This allows for the next potential route to be examined. Prior to examining the next potential route, however, at 1028, a determination is made as to whether the value of i is greater than the value of N. For example, if the value of i is more than the total number of potential route, then the last route may have been examined and there are no further routes to examine. As a result, flow of the method 1000 can proceed to 1030. But, if the value of i is not greater than N, then one or more additional potential routes may still need to be examined. As a result, flow of the method 100 can return to 1010 in FIG. 10A.

At 1030, route warrants are assigned to one or more vehicle systems based on the remaining potential paths. For example, the list of potential routes that passed the tests can be displayed to an operator of the system 100. The operator may select a route for assignment to a vehicle system as a route warrant for that vehicle system. This process may be repeated for additional vehicle systems.

In one embodiment, a method (e.g., for determining a route warranty for one or more vehicle systems) includes determining plural different paths for a trip of a first vehicle system from an origin location to a destination location in a transportation network formed from paths interconnected with each other at nodes, determining whether travel by the first vehicle system along the different routes fails one or more tests that restrict how the first vehicle system travels in the transportation network, and determining a route warranty for the first vehicle system based on the one or more tests. The route warranty reserves one or more of the paths for travel by the first vehicle system from the origin location to the destination location such that other vehicle systems are prevented from traveling on the one or more of the paths reserved by the route warranty.

In one aspect, determining the plural different routes includes determining at least one route from the origin location to the destination location that is not one or more of a linear path or a shortest distance path along the routes from the origin location to the destination location.

In one aspect, the method also includes determining a first node in the transportation network that is closer to the origin location than one or more other nodes of the nodes in the transportation network and determining a second node in the transportation network that is closer to the destination location than one or more other nodes of the nodes in the transportation network, wherein the paths are determined for the trip from the first node to the second node.

In one aspect, the nodes represent switches at intersections between the paths, and the route warranty that is determined reserves the one or more of the routes and one or more of the switches for travel by the first vehicle system from the origin location to the destination location such that other vehicle systems are prevented from traveling on the one or more of the paths and the one or more of the switches reserved by the route warranty.

In one aspect, determining whether the travel by the first vehicle system along one or more of the paths fails the one or more tests includes determining whether the travel along the one or more of the paths causes the first vehicle system to change direction by traveling over at least one switch in each of consecutive sets of switches in the one or more of the paths.

In one aspect, determining whether the travel by the first vehicle system along one or more of the routes fails the one or more tests includes determining whether the travel along the one or more routes causes the first vehicle system to travel along a first path of the paths, cross over a first switch to travel on a divergent path of the paths, and cross over a subsequent second switch to leave the divergent path and travel on a second path of the paths that forms a direct path between two locations with the first path.

In one aspect, determining whether the travel by the first vehicle system along one or more of the routes fails the one or more tests includes determining whether travel along the one or more routes causes the first vehicle system to travel on a first path of the paths that has one or more restrictions prohibiting travel on the first path by the first vehicle system.

In one aspect, determining whether the travel by the first vehicle system along one or more of the routes fails the one or more tests includes determining whether travel along the one or more routes causes the first vehicle system to double back and change direction multiple times during travel over a single switch.

In one aspect, determining whether the travel by the first vehicle system along one or more of the routes fails the one or more tests includes determining whether travel along the one or more routes causes the first vehicle system to travel over a first path of the paths that extends between two consecutive switches that are connected only by the first path.

In one aspect, a via region in the transportation network includes two or more switches that are one or more of within a designated distance of each other or within the designated distance of a vehicle station, and determining whether the travel by the first vehicle system along one or more of the routes fails the one or more tests includes determining whether travel along the one or more routes causes the first vehicle system to one or more of enter into or exit out of the via region along a first path of the paths that is the only path leading into or exiting out of the via region.

In one aspect, the method also includes communicating the route warranty to one or more switches located at one or more of the nodes in the transportation network and automatically controlling positions of the one or more switches in order to cause the first vehicle system to travel along the one or more routes reserved by the route warranty.

In one embodiment, a system (e.g., for determining a route warranty for one or more vehicle systems) includes one or more processors configured to determine plural different routes for a trip of a first vehicle system from an origin location to a destination location in a transportation network formed from paths interconnected with each other at nodes. The one or more processors also are configured to determine whether travel by the first vehicle system along the different routes fails one or more tests that restrict how the first vehicle system travels in the transportation network. The one or more processors also are configured to determine a route warranty for the first vehicle system based on the one or more tests. The route warranty reserves one or more of the paths for travel by the first vehicle system from the origin location to the destination location such that other vehicle systems are prevented from traveling on the one or more of the paths reserved by the route warranty.

In one aspect, the one or more processors are configured to determine whether the travel by the first vehicle system along one or more of the routes fails the one or more tests by determining whether the travel along the one or more of the routes causes the first vehicle system to change direction by traveling over at least one switch in each of consecutive sets of switches in the one or more of the routes.

In one aspect, the one or more processors are configured to determine whether the travel by the first vehicle system along one or more of the routes fails the one or more tests by determining whether the travel along the one or more routes causes the first vehicle system to travel along a first path of the paths, cross over a first switch to travel on a divergent path of the paths, and cross over a subsequent second switch to leave the divergent path and travel on a second path of the paths that forms a direct path between two locations with the first route.

In one aspect, the one or more processors are configured to determine whether the travel by the first vehicle system along one or more of the routes fails the one or more tests by determining whether travel along the one or more routes causes the first vehicle system to travel on a first path of the paths that has one or more restrictions prohibiting travel on the first path by the first vehicle system.

In one aspect, the one or more processors are configured to determine whether the travel by the first vehicle system along one or more of the routes fails the one or more tests by determining whether travel along the one or more routes causes the first vehicle system to double back and change direction multiple times during travel over a single switch.

In one embodiment, a method (e.g., for determining a track warranty for one or more rail vehicle systems) includes determining plural different routes for a trip of a rail vehicle system from an origin location to a destination location in a transportation network formed from tracks interconnected with each other at switches, determining whether travel by the rail vehicle system along the different routes fails one or more tests that restrict how the rail vehicle system travels in the transportation network, and determining a track warranty for the rail vehicle system based on the one or more tests, the route warranty reserving one or more of the tracks and one or more of the switches for travel by the rail vehicle system from the origin location to the destination location such that other rail vehicle systems are prevented from traveling on the one or more of the tracks and the one or more of the switches reserved by the track warranty.

In one aspect, determining whether the travel by the rail vehicle system along one or more of the routes fails the one or more tests includes one or more of: determining whether the travel along the one or more of the paths causes the rail vehicle system to change direction by traveling over at least one of the switches in each of consecutive sets of the switches in the one or more of the paths; determining whether the travel along the one or more paths causes the rail vehicle system to travel along a first track of the tracks, cross over a first switch of the switches to travel on a divergent track of the tracks, and cross over a subsequent second switch of the switches to leave the divergent track and travel on a second track of the tracks that forms a direct path between two locations with the first track; determining whether travel along the one or more paths causes the rail vehicle system to travel on a track route of the tracks that has one or more restrictions prohibiting travel on the first track by the rail vehicle system; determining whether travel along the one or more paths causes the rail vehicle system to double back and change direction multiple times during travel over a single switch of the switches; determining whether travel along the one or more paths causes the rail vehicle system to travel over a first track of the tracks that extends between two consecutive switches of the switches that are connected only by the first track; and/or determining whether travel along the one or more paths causes the rail vehicle system to one or more of enter into or exit out of a via region along a first track of the tracks that is the only track leading into or exiting out of the via region.

In one aspect, the method also includes automatically controlling positions of one or more of the switches in order to cause the rail vehicle system to travel along the one or more tracks and the one or more switches reserved by the track warranty.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended clauses, along with the full scope of equivalents to which such clauses are entitled. In the appended clauses, the terms “including” and “in which” are used as the plain-English equivalents of the respective terms “comprising” and “wherein.” Moreover, in the following clauses, the terms “first,” “second,” and “third,” etc. are used merely as labels, and are not intended to impose numerical requirements on their objects. Further, the limitations of the following clauses are not written in means-plus-function format and are not intended to be interpreted based on 35 U.S.C. §112, sixth paragraph, unless and until such clause limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter may include other examples that occur to those of ordinary skill in the art. Such other examples are intended to be within the scope of the clauses if they have structural elements that do not differ from the literal language of the clauses, or if they include equivalent structural elements with insubstantial differences from the literal languages of the clauses.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “an embodiment” or “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described systems and methods without departing from the spirit and scope of the inventive subject matter herein involved, it is intended that all of the subject matter of the above description or shown in the accompanying drawings shall be interpreted merely as examples illustrating the inventive concept herein and shall not be construed as limiting the inventive subject matter.

1. A method comprising:
determining plural different routes for a trip of a first vehicle system from an origin location to a destination location in a transportation network formed from paths interconnected with each other at nodes;
determining whether travel by the first vehicle system along the different routes fails one or more tests that restrict how the first vehicle system travels in the transportation network; and
determining a route warranty for the first vehicle system based on the one or more tests, the route warranty reserving one or more of the paths for travel by the first vehicle system from the origin location to the destination location such that other vehicle systems are prevented from traveling on the one or more of the paths reserved by the route warranty.

2. The method of claim 1, wherein determining the plural different routes includes determining at least one route from the origin location to the destination location that is not one or more of a linear path or a shortest distance path along the routes from the origin location to the destination location.

3. The method of claim 1, further comprising determining a first node in the transportation network that is closer to the origin location than one or more other nodes of the nodes in the transportation network and determining a second node in the transportation network that is closer to the destination location than one or more other nodes of the nodes in the transportation network, wherein the paths are determined for the trip from the first node to the second node.

4. The method of claim 1, wherein the nodes represent switches at intersections between the paths, and wherein the route warranty that is determined reserves the one or more of the paths and one or more of the switches for travel by the first vehicle system from the origin location to the destination location such that other vehicle systems are prevented from traveling on the one or more of the paths and the one or more of the switches reserved by the route warranty.

5. The method of claim 1, wherein determining whether the travel by the first vehicle system along the different routes fails the one or more tests includes determining whether the travel along the different routes causes the first vehicle system to change direction by traveling over at least one switch in each of consecutive sets of switches in the one or more of the paths.

6. The method of claim 1, wherein determining whether the travel by the first vehicle system along the different routes fails the one or more tests includes determining whether the travel along the different routes causes the first vehicle system to travel along a first path of the paths, cross over a first switch to travel on a divergent path of the paths, and cross over a subsequent second switch to leave the divergent path and travel on a second path of the paths that forms a direct path between two locations with the first path.

7. The method of claim 1, wherein determining whether the travel by the first vehicle system along the different routes fails the one or more tests includes determining whether travel along the different routes causes the first vehicle system to travel on a first path of the paths that has one or more restrictions prohibiting travel on the first path by the first vehicle system.

8. The method of claim 1, wherein determining whether the travel by the first vehicle system along the different routes fails the one or more tests includes determining whether travel along the different routes causes the first vehicle system to double back and change direction multiple times during travel over a single switch.

9. The method of claim 1, wherein determining whether the travel by the first vehicle system along the different routes fails the one or more tests includes determining whether travel along the different routes causes the first vehicle system to travel over a first path of the paths that extends between two consecutive switches that are connected only by the first path.

10. The method of claim 1, wherein a via region in the transportation network includes two or more switches that are one or more of within a designated distance of each other or within the designated distance of a vehicle station, and wherein determining whether the travel by the first vehicle system along the different routes fails the one or more tests includes determining whether travel along the different routes causes the first vehicle system to one or more of enter into or exit out of the via region along a first path of the paths that is the only path leading into or exiting out of the via region.

11. The method of claim 1, further comprising communicating the route warranty to one or more switches located at one or more of the nodes in the transportation network and automatically controlling positions of the one or more switches in order to cause the first vehicle system to travel along the one or more paths reserved by the route warranty.

12. A system comprising:
one or more processors configured to determine plural different routes for a trip of a first vehicle system from an origin location to a destination location in a transportation network formed from paths interconnected with each other at nodes, the one or more processors also configured to determine whether travel by the first vehicle system along the different routes fails one or more tests that restrict how the first vehicle system travels in the transportation network, wherein the one or more processors also are configured to determine a route warranty for the first vehicle system based on the one or more tests, the route warranty reserving one or more of the paths for travel by the first vehicle system from the origin location to the destination location such that other vehicle systems are prevented from traveling on the one or more of the paths reserved by the route warranty.

13. The system of claim 12, wherein the one or more processors are configured to determine whether the travel by the first vehicle system along the different routes fails the one or more tests by determining whether the travel along the different routes causes the first vehicle system to change direction by traveling over at least one switch in each of consecutive sets of switches in the different routes.

14. The system of claim 12, wherein the one or more processors are configured to determine whether the travel by the first vehicle system along the different routes fails the one or more tests by determining whether the travel along the different routes causes the first vehicle system to travel along a first path of the paths, cross over a first switch to travel on a divergent path of the paths, and cross over a subsequent second switch to leave the divergent path and travel on a second path of the paths that forms a direct path between two locations with the first path.

15. The system of claim 12, wherein the one or more processors are configured to determine whether the travel by the first vehicle system along the different routes fails the one or more tests by determining whether travel along the different routes causes the first vehicle system to travel on a first path of the paths that has one or more restrictions prohibiting travel on the first path by the first vehicle system.

16. The system of claim 12, wherein the one or more processors are configured to determine whether the travel by the first vehicle system along the different routes fails the one or more tests by determining whether travel along the different routes causes the first vehicle system to double back and change direction multiple times during travel over a single switch.

17. A method comprising:
determining plural different routes for a trip of a rail vehicle system from an origin location to a destination location in a transportation network formed from tracks interconnected with each other at switches;
determining whether travel by the rail vehicle system along the different routes fails one or more tests that restrict how the rail vehicle system travels in the transportation network; and
determining a track warranty for the rail vehicle system based on the one or more tests, the track warranty reserving one or more of the tracks and one or more of the switches for travel by the rail vehicle system from the origin location to the destination location such that other rail vehicle systems are prevented from traveling on the one or more of the tracks and the one or more of the switches reserved by the track warranty.

18. The method of claim 17, wherein determining whether the travel by the rail vehicle system along the different routes fails the one or more tests includes one or more of:
determining whether the travel along the different routes causes the rail vehicle system to change direction by traveling over at least one of the switches in each of consecutive sets of the switches in the one or more of the paths;
determining whether the travel along the different routes causes the rail vehicle system to travel along a first track of the tracks, cross over a first switch of the switches to travel on a divergent track of the tracks, and cross over a subsequent second switch of the switches to leave the divergent track and travel on a second track of the tracks that forms a direct path between two locations with the first track;
determining whether travel along the different routes causes the rail vehicle system to travel on a track route of the tracks that has one or more restrictions prohibiting travel on the first track by the rail vehicle system;
determining whether travel along the different routes causes the rail vehicle system to double back and change direction multiple times during travel over a single switch of the switches;
determining whether travel along the different routes causes the rail vehicle system to travel over a first track of the tracks that extends between two consecutive switches of the switches that are connected only by the first track; or
determining whether travel along the different routes causes the rail vehicle system to one or more of enter into or exit out of a via region along a first track of the tracks that is the only track leading into or exiting out of the via region.

19. The method of claim 17, further comprising automatically controlling positions of one or more of the switches in order to cause the rail vehicle system to travel along the one or more tracks and the one or more switches reserved by the track warranty.
